(19) United States
(12) Patent Application Publication
(10) Pub. No.: US 2007/0074820 A1
(43) Pub. Date: Apr. 5, 2007

(54) Machine for the manufacture of sheets ready prepared for immediate binding

(76) Inventors: Aldo Baioni, Rome (IT); Edoardo De Benedetti, Rome (IT)

Correspondence Address: NIXON & VANDERHYE, PC, 901 NORTH GLEBE ROAD, 11TH FLOOR, ARLINGTON, VA, 22203, US

(21) Appl. No.: 10/576,187

(22) PCT Filed: Oct. 15, 2004
(86) PCT No.: PCT/IT04/00567

§ 371 Date: Apr. 17, 2006

(30) Foreign Application Priority Data
Oct. 17, 2003 (IT) RM2003A000480

(51) Int. Cl. B32B 37/12; B32B 37/00; B65C 11/04; B32B 38/04; B32B 37/20; B32B 37/22

(52) U.S. Cl. 156/543; 156/578; 156/547; 156/552; 156/554; 156/555; 156/522; 156/361; 156/362

(57) ABSTRACT

A machine for the manufacture of sheets ready prepared for immediate binding comprises a pair of upper and lower rollers which drive a strip of paper from a reel of a feeder. Downstream of the rollers there is a contact cutter which cuts the strip of paper into sheets which are subsequently gripped by two lower and upper conveyor belts. At least one applicator for applying a band of silicone material causes the latter to follow a path towards the sheets which advance between the conveyor belts. A dispenser applies an intermittent jet of liquid adhesive substance onto the side of the band which is to be brought into contact with the sheets of paper. At the outlet of the machine there is a device for collecting sheets in reams.

The present invention relates to a machine for the manufacture of a sheet ready prepared for immediate binding.

European Patent No. 0,919,400 describes a type of sheet which has a strip of adhesive substance or double-sided tape along at least one of its edges. A strip of silicone material is positioned in a releasable manner on the strip of adhesive substance or double-sided tape and has at least one portion which is not joined to the strip of adhesive substance or double-sided tape. When a sheet is placed on top of another one, this portion of the strip of silicone material is intended to be gripped and pulled in order to achieve removal of the whole strip of silicone material and adhesion of the sheet, from which the strip is removed, to another sheet which is placed on top of it. If all the strips of silicone material of all the sheets placed on top of each other are removed, immediate binding of all those sheets is obtained.

The cited patent describes the sheet as a product, but does not provide any indication as to how to produce it, namely how to apply the strip of adhesive substance or double-sided tape or how to position a strip of silicone material on top of it.

According to a second aspect thereof, the abovementioned European Patent No. 0,919,400 describes an adhesive tape having on one of its sides, alternately, sections with adhesive substance which are cold-activated and shorter sections without any adhesive substance. The tape may also consist of double-sided tape. In the cited patent it is stated that the tape may be applied onto the sheet manually or by means of a special device, available at the outlet of a printer. However, with regard to the device, in this patent it is stated that it does not form part of that invention.

From the above short description of the cited European Patent No. 0,919,400 it can be understood that a product such as that discussed may be produced, but only manually and is therefore completely impractical owing to the amount of time required. In fact, in that patent, starting with sheets already cut to the desired format or forming part of continuous stationery, it is stated that it is possible to apply a strip of adhesive substance onto a sheet and cover it with a strip of silicone material; or it is possible to apply an adhesive tape which can be easily separated or a double-sided tape, with portions devoid of adhesive substance, onto individual sheets.

In the first case, namely application of the strip of adhesive substance and covering thereof, no description is given as to how it is possible, manually, to apply in a precise manner and without irregularities a strip of adhesive substance and then cover it in an exact manner with a strip of silicone material, so that it does not start to have a gluing effect before the desired time. Moreover, with reference to the tape, it is not clarified how it is possible to produce an adhesive tape which transfers onto a sheet, when it is applied thereon, a cold adhesive substance and how the said adhesive tape may be removed therefrom as required without taking with it the adhesive substance as well.

It is furthermore difficult to imagine a printer which is able to dispense onto the sheets output from it portions of tape in order to produce a sheet ready prepared for immediate binding.

By way of conclusion, an expert in the paper-making industry sector understands that the cited patent describes a product which has positive aspects, but which needs to be developed considerably in order to have an application on an industrial level.

It is precisely the object of the present invention to produce a sheet ready prepared for immediate binding, which is truly effective.

Another object of the invention is to achieve rapid and low-cost production of a sheet ready prepared for immediate binding.

A further object of the invention is to provide a sheet ready prepared for immediate binding, which may be used in conventional equipment such as printers, faxes, etc., in the same manner as ordinary sheets.

Yet another object of the invention is to ensure the production of a sheet, ready prepared for immediate binding in the various formats desired, in a precise manner and without difficulty or loss of time.

According to the present invention it is envisaged providing a machine for the manufacture of sheets ready prepared for immediate binding of the type mentioned above, in which an applicator for applying a non-adhesive band onto the paper material advancing in a continuous manner along a feeding plane comprises a band-holder drum, a travel system for moving the band towards the continuously advancing paper material, consisting of rollers and band-guiding pulleys; a dispenser of liquid adhesive substance, for application of the adhesive substance in the form of a jet onto the side of the band which is to be placed in contact with the paper material, over a desired length; a pressure unit including, symmetrically with respect to the feeding plane of the paper material, a lower drive roller situated underneath the paper material and a pressure roller located above in a projecting manner in contact with the lower drive roller, with the arrangement in between of the band bearing the adhesive substance and the paper material, so as to cause the band to adhere to the advancing paper material.

When the band is applied to separate sheets, the applicator for applying the non-adhesive band also comprises a band cutter for cutting the band at the terminal end of each sheet.

Advantageously the machine comprises an encoder for activating a contact cutter for cutting the strip of paper material into sheets.

Conveniently, the sheets are gripped by two conveyor belts, one upper and one lower, which are arranged with mirror-symmetry with respect to the feeding plane of the paper material in sheet form downstream of the contact cutter and the drive rollers, which plane is coplanar with the horizontal feeding plane of the paper in strip form, the conveyor belts having a transverse width smaller than that of the sheets conveyed and a speed greater than the peripheral speed of the driving rollers.

The machine according to the present invention also comprises a scoring wheel and a photocell for controlling feeding of the paper material.

Moreover, it comprises an electronic control unit and a control panel for entering the desired parameters.

The present invention will now be described with reference to a preferred embodiment thereof, it nevertheless being understood that constructional variations may be made without thereby departing from the scope of protection of the present invention and with reference to the figures in the accompanying drawings in which:

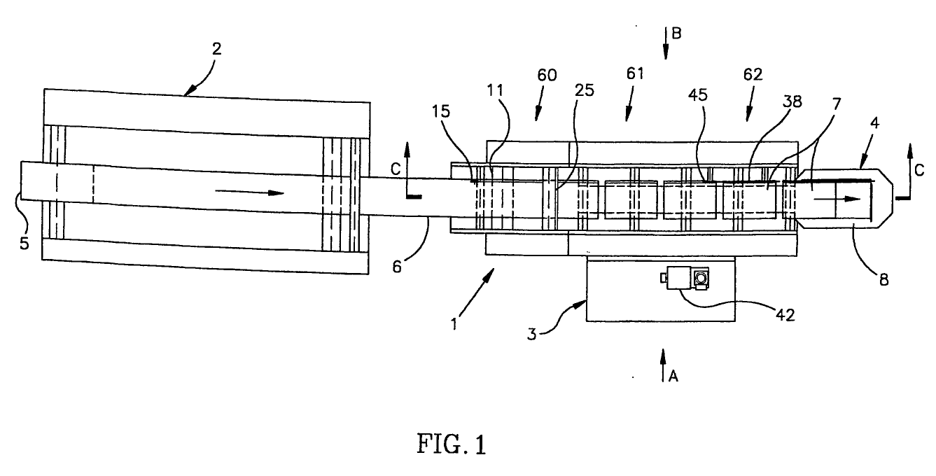

FIG. 1 shows a schematic plan view of a machine according to the present invention for the production of sheets ready prepared for immediate binding, including the paper feeder;

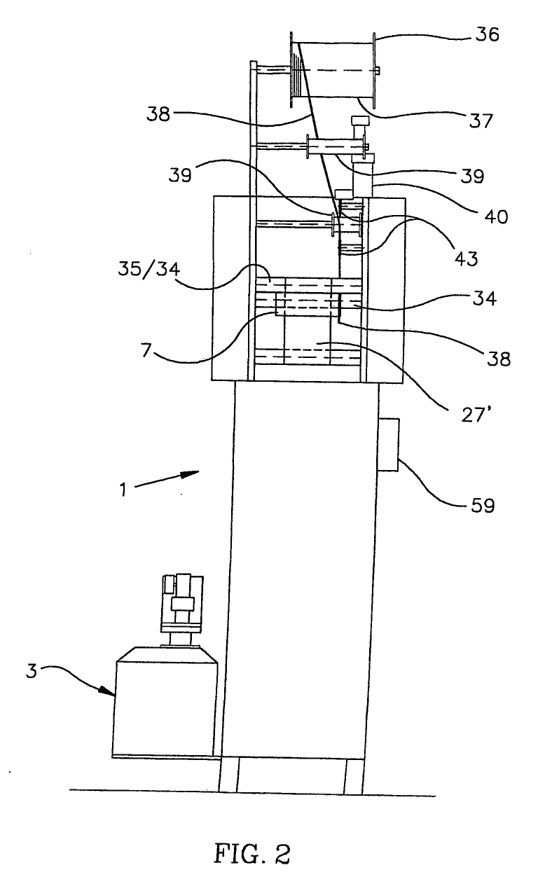

FIG. 2 shows a schematic front view from the side where the ready-prepared sheets are output from the machine according to FIG. 1;

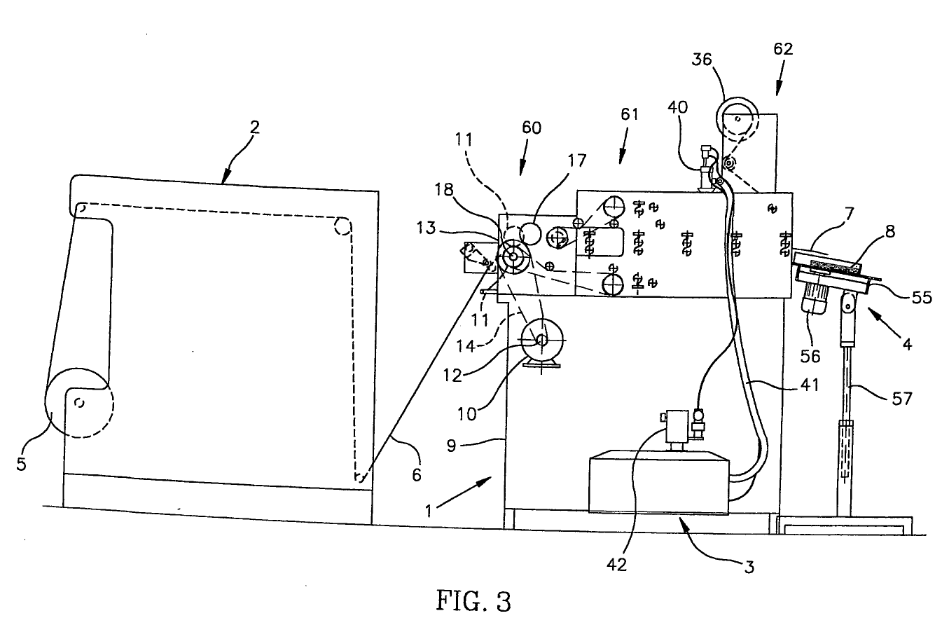

FIG. 3 shows a schematic side view, in the direction of the arrow A, of the machine according to FIG. 1;

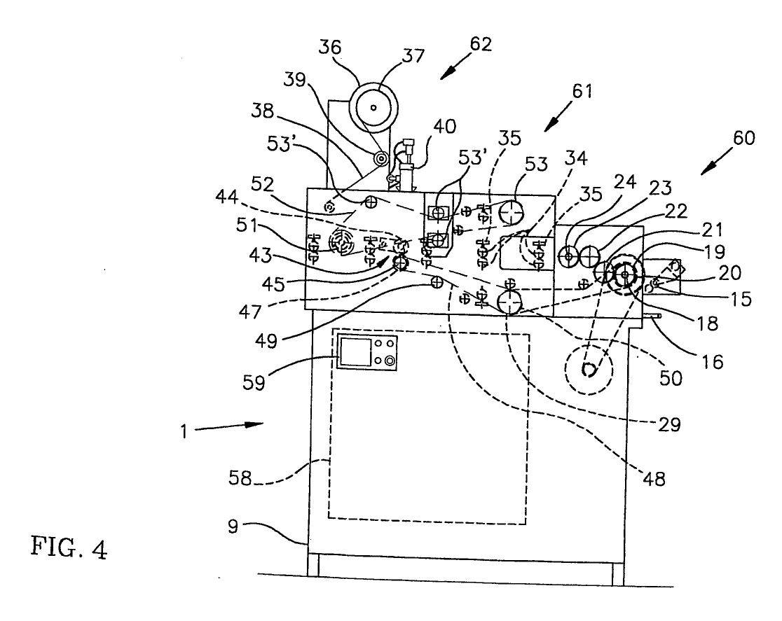

FIG. 4 shows a schematic side view, in the direction of the arrow B, of the machine according to FIG. 1, without paper feeder;

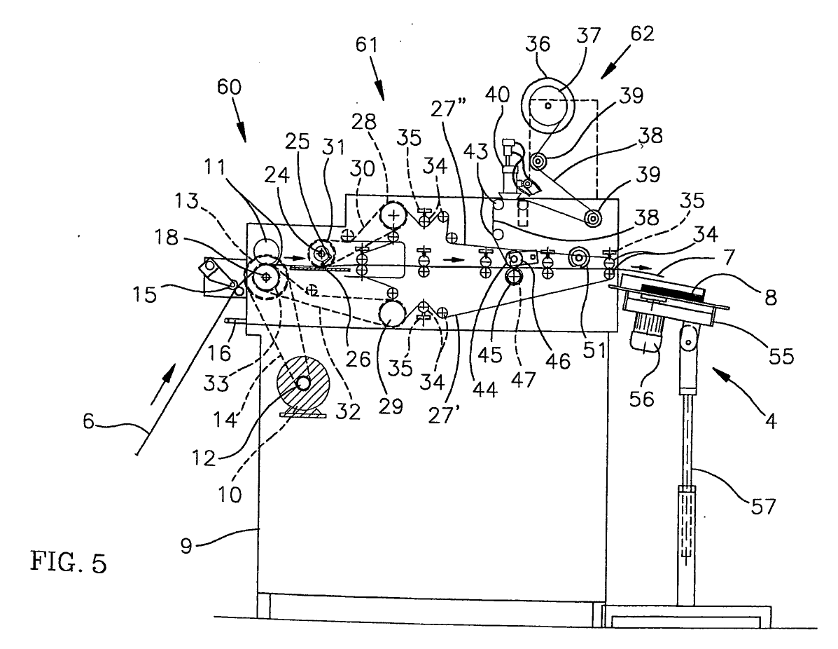

FIG. 5 shows a schematic longitudinal section along the plane C—C of the machine according to FIG. 1, without paper feeder.

With reference to the drawings, FIG. 1 shows the general appearance of the machine indicated by 1 which produces the sheets ready prepared for immediate binding, said machine being connected to a device feeding paper from a reel or a taut-paper unwinder denoted by 2. The unwinder, which is not described in detail since it may be of any known type, is able to handle different types of paper reels.

For the sake of simplicity of the description, the machine 1 shown is designed so that there is a single production line with one track and so that a single ream of sheets ready prepared for immediate binding is obtained from the single reel of the feeder 2. Obviously the machine could be designed so as to have two or more parallel tracks for production of the reams of sheets. In this case, for feeding the paper, an unwinder of the known type for so-called two-up reels would be used, longitudinal separation of the strip of paper being performed downstream of the machine by means of a special central circular cutter, so as to produce two or more strips of paper from which two or more reams of finished sheets will be obtained. In the remainder of the description, brief reference will be made to any modifications to be made to the machine in order to obtain two or more tracks and a corresponding increase in production.

The machine 1 is shown without the entire housing which is situated above the paper during its feeding movement. In the machine 1 it is possible to note a body mounted on the left-hand side, said body consisting of a device 3 supplying an adhesive substance in the liquid state and a front device 4 for collecting the sheets ready prepared for immediate binding, namely the finished product, in the form of a ream. In FIG. 2, which is a front view of the machine 1, for the sake of ease of illustration, the front collecting device 4 is not shown. FIG. 3, which is a side view in the direction of the arrow A of FIG. 1, namely from the left-hand side when viewing the machine from the point where the collecting device 4 for the finished product is provided, also shows in very schematic form the reeled paper, feeder, which feeder is however not shown for the sake of ease of illustration in FIGS. 4 and 5. FIG. 4 also does not show the device 4 for collecting the end product.

With particular reference to FIGS. 1 and 3, the reeled paper feeder 2 is a machine which unwinds a strip of paper 6 from a reel 5. Inside the feeder, by means of suitable transmissions and feed adjusting devices (not shown since they are known), the strip of paper 6 reaches the machine 1.

The finished product is a sheet—indicated by 7—to which a band 38 of silicone or polyester material is applied and which is collected in the form of a ream 8 with the other sheets in succession inside the collecting device 4. In the remainder of the description, “band of silicone material” or the like is understood as meaning a non-adhesive band able to avoid adhesion between an adhesive substance, which joins together the band and an underlying sheet of paper, and a sheet of paper situated above the said band.

The machine 1 has a base 9 containing a motor 10 which is substantially the only operating means for feeding both the paper and the band of non-adhesive—for example silicone—material.

Broadly speaking the machine 1 comprises a station 60 for receiving the strip of paper and for cutting it into sheets and a station 61 for feeding the sheets and for applying onto the sheets the band of non-adhesive—for example silicone—material and cutting it. Both the stations mentioned above are situated on the frame 9 of the machine 1. Inside the frame 9, the motor 10 transmits the movement to a pair of upper and lower drive rollers 11, 11 via a pinion 12 which is fixed onto the shaft of the motor 10 and a toothed pulley 13 arranged coaxially with the lower drive roller 11, by means of a toothed belt 14. The upper and lower rollers 11, 11 drive the strip of paper 6 supplied from the reel 5 of the feeder 2. A scoring wheel 15 situated upstream of the upper and lower rollers 11 also forms part of the station 60 for receiving and cutting the strip of paper, as does a photocell 16 for controlling feeding of the paper.

As shown in FIG. 3, an encoder 17 is mounted on the toothed pulley 13. This encoder is in the form of a ring having along its periphery, with a length equal to the height desired for the sheets, a rubber ring for friction feeding in synchronism with, but in the opposite direction of rotation to that of the toothed pulley 13. The function of the encoder 17 will be discussed in more detail below.

The axis 18 of the toothed pulley 13 also coincides with the axis of the lower roller 11. The axis 18, on the opposite side to the toothed pulley 13, supports, as shown in FIG. 4, a toothed pulley 19 and a gear wheel 20. The gear wheel 20 meshes with a train of gear wheels 21, 22, 23 meshing successively. The gear wheel 23 has an axis 24 on which a contact cutter 25 (FIG. 5) situated above the zone where the strip of paper 6 passes through and a metal support surface 26 are mounted. In this section the strip of paper 6 advances along a substantially horizontal plane.

Downstream of the contact cutter 25, the paper advances in sheets as shown more clearly in FIG. 1. The sheets are taken up by the station 61 for feeding the sheets and for applying and cutting the band of silicone material. As shown in FIG. 5, this station comprises two lower and upper conveyor belts 27′, 27″ which are arranged with mirror-symmetry with respect to the sheet feeding plane which is coplanar with the horizontal plane of feeding of the strip 6 of paper. Alternatively, the sheets may be fed, conveyed by so-called vacuum belts which ensure that they remain parallel during their feeding movement.

Referring again to FIG. 1, the transverse width of the conveyor belts 27′, 27″ is less than the width of the sheets 7 conveyed by them so that a side edge of the said sheets remains free from contact with the conveyor belts. The conveyor belts 27′, 27″ are operated by respective upper and lower toothed pulleys 28 and 29. The upper pulley 28 is connected by means a toothed belt 30 to a toothed pulley 31 integral with the shaft 24. The lower toothed pulley 29 is connected by means of a toothed belt 32 to a toothed pulley 33 integral with the shaft 18. The two conveyor belts 27′ and 27″ or double conveyor belt 27′, 27″ are mounted on idle rollers which are denoted generally by 34. Some of these rollers 34, which do not have a simple driving function, may be adjusted in terms of their position by means of adjusting means indicated generally by 35. In this way feeding of the sheets of paper may be regulated at all times.

The conveyor belts 27′, 27″ have a speed which is slightly greater than that of the rollers 11, 11 driving the strip of paper 6. Therefore the sheets 7 are spaced from each other so as to create that free portion of the band 38 useful for gripping with a hand when performing binding.

The conveyor belts 27′ and 27″ have a width less than that of the strip of paper 6 and therefore the sheets 7 so that a side edge remains free for application of the band 38 of silicone material.

The station 61 for feeding the sheets and applying the band of silicone material has an applicator 62 for applying the band of silicone material according to the invention. In the case where the machine has two or more tracks, there is one band supplying and application device per track, designed so as to allow application both on the right-hand side and on the left-hand side of the sheet. The applicator 62 comprises in a position situated above the top part of the machine a band-holder drum 36 which is freely rotating and supports a reel 37 containing the band 38. The band 38, which is supplied from the reel 37, follows a path where it is moved towards the sheets which advance between the conveyor belts. Along this path there are two band guide rollers 39, 39 which convey the band to a substantially horizontal section of its travel movement towards the sheets. This horizontal section has, mounted above it, a device 40 for dispensing liquid adhesive substance, which is connected to a tube 41 for supplying to the tank 3 the adhesive substance (FIG. 3). The adhesive substance may be chosen as desired. An adhesive of the hot-melt type, with a working temperature of about 160-170° C., is preferred. The tank 3 for the adhesive substance is provided with a controlled pumping device 42 for supplying, at the desired flowrate, pressure and temperature, the adhesive substance to the dispenser 40. The tank 3, the dispenser 40 and the pumping device 42 are of the type which are conventionally known and are not further described.

The dispenser 40 has the function of applying an intermittent metered jet of the adhesive substance onto the side of the band 38 intended to be brought into contact with the sheets of paper 7. The travel of the band 38 underneath the dispenser 40 is guided by pulleys which are denoted generally by 43 (FIG. 5) and which convey it to a pressure unit arranged symmetrically with respect the feeding plane of the sheets 7. The pressure unit 44 comprises a lower drive roller 45 situated underneath the sheets and a pressure roller 46 which is located above in a projecting manner and causes the band 38 to adhere onto the sheet of paper 7 which advances by means of the double conveyor belt 27′, 27″. The lower drive roller 45 and the pressure roller 46 receive between them the sheets and the band of silicone material onto which the adhesive substance has been dispensed by the dispenser 40. As shown in FIG. 4, the lower drive roller 45 is actuated by a coaxial toothed pulley 47 having, travelling over it, a toothed belt 48 tensioned by a tensioning device 49 and operated by a toothed pulley 50 which is fixed onto the said shaft of the toothed pulley 29.

If the paper material on which the applicator 62 of the band of silicone material acts consists of sheets as described above, the band of silicone material 38 is cut by a cutter 51 (FIG. 5) which is actuated via a flexible belt 52 (FIG. 4) by a toothed pulley 53 coaxial with the toothed pulley 28, with the arrangement of tensioning devices 53′ in between. A tray 54 for collecting the sheets 7 in reams 8 is positioned at the outlet of the machine 1 according to the present invention. The tray forms part of the collecting device 4, which comprises a vibrating plate 55 operated by a motor 56 and positioned in an inclinable manner on a telescopic pedestal 57.

The sheets which are defective or in any case do not comply with the parameters entered, monitored by special detectors not shown in detail, are removed from the other sheets and deviated by the track into underlying pockets before reaching the tray 54. These pockets are also not shown in the drawings. The product complying with the parameters entered is instead conveyed to the collecting device 4. The collecting device 4 is shown as having only one stage. However, it could consist of several stages so as to create in succession blocks, each of which is formed by the programmed number of sheets. A greater number of stages acts as an intermediate storage device. In this way, the machine could function autonomously without any operator who is not obliged to be present in order to check that the complete block of sheets has been formed and remove it so that formation of the next block may start immediately.

If, on the other hand, the paper material is continuous stationery having already predetermined weakening lines which delimit at the top and at the bottom a sheet from the consecutive sheets, the cutter 51 is not activated, except at the end of the continuous stationery. In this case, the collecting device 4 may also be formed in a different manner.

The base 9 of the machine 1 houses an electronic control unit 58 and a control panel 59. The electronic control unit 58 controls all the component parts of the machine, while the operator enters in the control panel 59 all the desired parameters such as the number of sheets per minute and the characteristics which the sheet ready-prepared for immediate binding must have. Since all the adjustments as regards the configuration and management of the machine may be performed via the control panel, the latter constitutes an interface between the operator and the machine. For this reason, the control panel could also be advantageously formed in the manner of a touch-screen panel or monitor which, on the one hand, continuously displays 5 the machine status and, on the other hand, would allow the operator to operate it by means of simple finger pressure. The electronic control unit 58 interacts with the production line, being connected on the one hand to all the detection devices, such as for example the paper breaking, end of reel, reel diameter or feed speed devices and, on the other hand, to all the machine components for adjustment thereof.

The operating principle of the machine is as follows.

From the feeder 2 the strip of paper 6 is fed to the station 60 for receiving the strip of paper and cutting it into sheets where it is driven by the upper and lower drive rollers 11, 11 into the station for receiving and cutting the paper.

Before reaching the drive rollers 11, 11, the strip of paper undergoes in the vicinity of its side edge scoring by the unit with the scoring wheel 15. The purpose of this scoring operation is to eliminate the adhesive effect, also as a result of static electricity, of the sheets on the parts of the machine with which they will come into contact. The photocell 16 also located downstream of the drive rollers 11, 11 checks for correct feeding of the strip 6 of paper and, if this is not the case, interrupts operation of the machine. Immediately downstream of the drive rollers 11, 11, the contact cutter 25 is made to act on the strip of paper 6 which advances on the support surface 32 by means of a command supplied from the encoder 17 via which the desired length of the sheet is established.

The individual sheets are taken up by the station 61 for feeding the sheets and applying onto the sheets the band from the double conveyor belt 27′, 27″ which has a speed slightly greater than the peripheral speed of the drive rollers 11, 11 such that the sheets may be fed forward on the double conveyor belt 27′, 27″ slightly spaced from each other. The band of silicone material 38, onto which the dispenser 40 has previously applied a jet of adhesive substance, is applied onto the upper side of the sheets, in the vicinity of their edges. As mentioned above, the adhesive substance is applied onto the side of the band intended to come into contact with the sheets. The adhesive substance is not applied along the whole length of the band, but a portion thereof is kept periodically free, said portion corresponding to the distance between one sheet and the next, plus a small section useful for improving gripping of the band. The band is cut by the cutter 51 exactly at the end of each sheet, i.e. in the bottom terminal end, or in the case of other paper material, such as continuous stationery, at the terminal ends of the stationery. Then the double conveyor belt 27′, 27″ discharges the individual sheets provided with a band of silicone material preferably projecting from one end thereof and these sheets are stacked in a ream 8 on the tray 54 of the vibrating collection device 4.

It is understood that many variations may be made to the machine described above. For example, it is possible to double or change the position where the band of non-adhesive, for example silicone, material is applied and therefore produce sheets ready prepared for immediate binding, which can be joined together at different points. It is also possible to vary the size of the sheets by changing the diameter of the wheel associated with the encoder which emits the command for operation of the cutter for cutting the strip of paper into sheets. Obviously the width of the sheets may also be varied by mounting a reel of different height and conveyor belts of different width.

Alternatively, the adjustments for changing the format of the sheets may be managed by a dedicated electronic system which interacts with the means for operation of the machine components. In this way the time required for setting-up the machine is reduced and mechanical operations for replacement of the components and for manual adjustment of their arrangement are not required.

Although all the machine components have not been illustrated in the above description, the person skilled in the sector will obviously understand which accessories and devices are important for operation thereof. These include the sheet counters, such as the counter resettable after every operation, the resettable general counter and the non-resettable permanent general counter. The latter is particularly useful for determining the need for maintenance or for detecting the production data, useful for example for production performed under franchise or in different locations.

The same machine described above for application of a strip of adhesive substance to individual sheets, may be used, with slight modifications, for application of the strip of adhesive substance also onto continuous stationery. Among other things, in this case, with regard to the two cutters, the cutter for the sheets of paper in the station 60 must be removed and the cutter for the band of silicone material in the station 61 must be operated so as to cut only the terminal end of the continuous stationery.

1. Machine for the manufacture of sheets ready prepared for immediate binding, having a strip of adhesive substance along one of its edges and a strip of silicone material positioned in a releasable manner on the strip of adhesive substance, the sheets consisting of paper material in the form of single sheets or in strip form such as continuous stationery provided with transverse lines with predetermined weakening, characterized in that it comprises along at least one production line thereof at least one applicator for applying a non-adhesive band onto the paper material advancing in a continuous manner along a feeding plane, said at least one applicator comprising:
a rotatable band-holder drum in a position situated above the paper material which advances in a continuous manner;
means which define a travel path for movement towards the continuously advancing paper material, consisting of rollers and band-guiding pulleys;
a dispenser of liquid adhesive substance, supplied from a tank equipped with a pumping device, for application of the adhesive substance in the form of a metered jet onto the side of the band which is to be brought into contact with the paper material, over a desired length;
a pressure unit including, symmetrically with respect to the feeding plane of the paper material, a lower drive roller situated underneath the paper material and a pressure roller located above in a projecting manner in contact with the lower drive roller, with the arrangement in between of the band bearing the adhesive substance and the paper material, so as to cause the band to adhere to the advancing paper material.

2. Machine according to claim 1, characterized in that the applicator for applying the non-adhesive band onto the paper material also comprises a band cutter which can be activated at the terminal end of the advancing paper material.

3. Machine according to claim 1, characterized in that it also comprises a pair of upper and lower drive rollers able to drive along its feeding plane the paper material in strip form supplied from a reel positioned inside a feeder.

4. Machine according to claim 3, characterized in that it also comprises an encoder associated with a wheel rotating in synchronism with the drive rollers, said wheel having a circumference with a length equal to the desired height of the sheets and a contact cutter for performing cutting into sheets, situated above the zone where the strip of paper material passes and actuated by means of the encoder.

5. Machine according to claim 4, characterized in that it also comprises two conveyor belts, one upper and one lower, which are arranged with mirror-symmetry with respect to the feeding plane of the paper material in sheet form downstream of the contact cutter and the drive rollers, which plane is coplanar with the horizontal feeding plane of the paper in strip form, the conveyor belts having a transverse width smaller than that of the sheets conveyed and a speed greater than the peripheral speed of the drive rollers.

6. Machine according to claim 1, characterized in that it comprises so-called vacuum belts for feeding the paper material in the form of sheets.

7. Machine according to claim 1, characterized in that it also comprises a scoring wheel for the paper material.

8. Machine according to claim 1, characterized in that it also comprises a photocell for controlling feeding of the paper material.

9. Machine according to claim 1, characterized in that it also comprises an electronic control unit and a control panel for entering the desired parameters.

10. Machine according to claim 1, characterized in that it also comprises a device for collecting the finished product.

11. Machine according to claim 1, characterized in that it also comprises a single-stage device for collecting the finished product.

12. Machine according to claim 1, characterized in that it also comprises a multiple-stage device for collecting the finished product.

13. Machine according to claim 1, characterized in that it comprises, along a production line, two or more tracks with at least one device for collecting the finished product at the end of each track.

14. Machine according to claim 1, characterized in that said non-adhesive band consists of silicone material.

15. Machine according to claim 1, characterized in that said non-adhesive band consists of polyester.

16. (canceled)
